(19) United States
(12) Patent Application Publication
(10) Pub. No.: US 2009/0254299 A1
(43) Pub. Date: Oct. 8, 2009

(54) Dental Prosthesis Fabrication Based on Local Digitization of a Temporary

(75) Inventor: Eyal Tarazi, Caesarea (IL)

Correspondence Address: Sunstein Kann Murphy & Timbers LLP, 125 SUMMER STREET, BOSTON, MA, 02110-1618, US

(73) Assignee: OPTIMET, OPTICAL METROLOGY LTD., Jerusalem (IL)

(21) Appl. No.: 12/407,381

(22) Filed: Mar. 19, 2009

Related U.S. Application Data
(60) Provisional application No. 61/042,425, filed on Apr. 4, 2008.

(51) Int. Cl. G01N 9/36; A61C 13/34

(52) U.S. Cl. 702/137; 433/215

(57) ABSTRACT

A system and methods for obtaining and processing data requisite for fabrication of a dental restorative prosthesis. A dental temporary is fashioned at a site of patient treatment, and fitted in the patient's mouth. The temporary is then characterized by three-dimensional digital data based on distances measured by means of three-dimensional co-ordinate measuring equipment. The three-dimensional data are transmitted to a fabrication site, where a prosthesis may be fabricated. Additionally, information based upon the three-dimensional digital data characterizing the temporary may also be provided to a dentist at the site of patient treatment. The prosthesis design may be edited prior to fabrication.

The present invention claims the priority of U.S. Provisional Patent Application 61/042,425, filed Apr. 4, 2008, and incorporated herein by reference in its entirety.

### FIELD OF THE INVENTION

The present invention relates to using temporary dental prostheses, formed within the mouth of a patient, for deriving morphological information used in the fabrication of fixed dental prosthetic devices, such as crowns and bridges, for purposes of restorative dentistry.

### BACKGROUND ART

Current practice in the field of restorative dentistry entails taking an impression in the mouth of a patient in order to provide an exact mold for a crown or a bridge. The dentist provides the impression to a dental lab where a template is cast that may then be digitized for fabrication of a permanent prosthesis using three-dimensional CAD/CAM techniques. The permanent prosthesis is then shipped to the dentist and installed in the patient's mouth. For the duration of this process, which may typically take a week or two, or even three, the patient is fitted with a temporary prosthesis fashioned by the dentist. Temporary (or interim) prostheses (generally referred to as “temporaries”) are typically made of an acrylic material and serve to protect dental surfaces that have been prepared to receive the final restoration and to prevent damage by food or microorganisms and sensitivity to hot or cold. The current process as heretofore described is, however, fraught with inconvenience, since it entails the physical shipment of an impression from the dentist's office to the dental lab, moreover, a loss of precision is inherent in the process of successive replication by taking an impression, casting a template, and then subsequent digitization. Improvements in precision and convenience are thus to be desired. Additional source imprecision is due to the retraction cord used in some cases to open the gingival sulcus prior to taking the impression.

Definitions: As used herein and in any appended claims, the terms “dental prosthesis” and “restorative” will be used in a general sense, to encompass crowns, or bridges, implants, veneers, or any other restorative structures of that class, as well as abutments employed to retain implants. Moreover, any use of any of the foregoing terms is to be understood as encompassing the entire class of dental prostheses, unless the context dictates otherwise.

### SUMMARY OF THE INVENTION

In accordance with preferred embodiments of the present invention, systems and methods are provided for obtaining data requisite for fabrication of a dental restorative prosthesis. The method may have steps of:
a. fashioning a temporary at a site of patient treatment, the temporary characterized by an exterior and an interior surface;
b. fitting the temporary within a mouth of a patient;
c. obtaining three-dimensional digital data characterizing the temporary based on the distances measured by means of a three-dimensional co-ordinate measuring device; and
d. transmitting the three-dimensional digital data to a fabrication site.

In accordance with an alternative embodiment of the invention, the restorative dental prosthesis is fabrication on the basis of the three-dimensional data. Information may also be provided to a dentist at the site of patient treatment, where the information is based upon the three-dimensional digital data characterizing the temporary. Such information may include the thickness of the prosthesis in different portions of the prosthesis, prosthesis end-line quality, and the insertion axis of the prosthesis.

In accordance with other embodiments of the invention, the step of obtaining three-dimensional data includes measuring distances relative to at least one fiducial position of points on the exterior and interior surfaces of the temporary. Measuring distances may include measuring distances along paths collinear with an optical axis of a non-contact distance probe. The measurements may be performed intraorally. The temporary may be an interim prosthesis, and, more specifically, may be a crown or a bridge. The step of measuring distances may include measuring multiple sides of the temporary and co-registering data obtained on each side. Such registration may be done by external registration features on a holder. The method may also include measuring distances and the three dimensional shape of a pickup impression in which the temporary is embedded.

In accordance with another aspect of the present invention, a computer-implemented method is provided for supplying specifications for fabrication of a dental prosthesis. Such a method has steps of:
a. digitizing distances measured with respect to a temporary;
b. converting the distances to three-dimensional data characterizing the temporary;
c. receiving the three-dimensional data at a remote location; and
d. designing a prosthesis on the basis of the received three-dimensional data, thereby creating a prosthesis design.

In accordance with further embodiments of the invention, a prosthesis is fabricated on the basis of the prosthesis design. Input may be received for editing the prosthesis design, and the computer-implemented method may further comprise editing the prosthesis design on the basis of the input received.

In accordance with yet another aspect of the invention, a computer program product is provided. The computer program product, for use on a computer system that supplies specifications for fabricating a dental prosthesis, has computer readable program code that includes:
a. program code for reading digitized distances measured with respect to a dental temporary by means of three-dimensional co-ordinate measuring equipment;
b. program code for converting the distances to three-dimensional data;
c. program code for designing a prosthesis on the basis of the three-dimensional data, thereby creating a prosthesis design; and
d. program code for editing the prosthesis design prior to transmission of the prosthesis design to a remote location for prosthesis fabrication.

### BRIEF DESCRIPTION OF THE DRAWINGS

The invention will more readily be understood by reference to the following description taken with the accompanying drawings which depict the used of impression scanning to characterize an implant in a patient's mouth. The drawings are intended to provide a better understanding of the present invention, but are in no way intended to limit the scope of the invention.

FIG. 1 is a cutaway view of a multiple angle scanning system depicting the scanning of a spherical object in accordance with embodiments of the present invention;

FIG. 2 is a flowchart depicting basic steps in the digitization of a dental prosthesis in accordance with an embodiment of the present invention; and

FIG. 3 schematically depicts a flow of information gathered at a point of dental service to a locale, which may be remote, where a permanent prosthesis is fabricated.

### DETAILED DESCRIPTION OF SPECIFIC EMBODIMENTS

Preferred embodiments of the present invention are described in the following pages. Use of scanning and digitization, by whatever method, of dental structures or of impressions or templates, may be further appreciated by reference to the description provided in U.S. Pat. No. 7,375,827, issued May 20, 2008, entitled “Digitization of Undercut Surfaces Using Non-Contact Sensors,” and US Published Patent Application No. 2007/0293769, entitled “Double-Sided Measurement of Dental Objects Using an Optical Scanner,” published Dec. 20, 2007. Both of the foregoing publications are incorporated herein by reference in their entirety. Additionally, co-pending U.S. patent application Ser. No. 12/401,668, filed Mar. 11, 2009, entitled “Method and Apparatus for Intra-oral Digitization Scanning,” is incorporated herein in its entirety.

The customary course of restorative dentistry begins in the dentist's office. The first step entails taking a preliminary impression of a patient's mouth, typically before anesthesia is given, so as to ensure that the preliminary impression accords with the normal bite of the patient. Surfaces of teeth are prepared to receive the crown or veneer, etc., and then, either using the preliminary impression, or else directly inside the patient's mouth, the dentist forms a “temporary.”

Definition: As used herein and in any appended claims, a “temporary” is used broadly to encompass any provisional structure formed in the mouth of a patient, the inner surface of which conforms to the complementary structure in the mouth of the patient such as an underlying prepared tooth surface or abutment. A temporary thus includes an “interim prosthesis” or “temporary restoration” or any other dental prosthesis, either fixed or removable, that serves for a limited period of time, after which it is replaced by a definitive prosthesis that is designed for long-term use. It also refers to a mold or cube that acquires the interior shape conforming to the base upon which a definitive prosthesis will be cemented.

The temporary may be formed from any of a variety of plastic reshapable materials, which vary in the advantages they provide under differing sets of circumstances. Some typical temporary materials, provided here by way of example and without limitation, include the distinct classes of polymethyl methacrylate (PMMA) and polyethyl methacrylate (PEMA) acrylics that polymerize to form reasonably strong structures that are readily smoothed and polished. Additionally, bis-acryl resin composites may be used as temporary materials, and, like any material used in the formation of temporary prostheses, are within the scope of the present invention.

The material used for a temporary is typically formed by mixing powder and liquid, and the material is allowed to cure until it achieves a putty consistency, at which time the dentist inserts it into the patient's mouth over the tooth that has been prepared to receive it. The raw material for formation of a temporary may also be supplied to the dentist preformed into one of a number of starting shapes, to facilitate the process of forming a finished interim prosthesis.

Definition: As used herein and in any appended claims, the word “fashion,” in its various grammatical forms, refers to the process of advancing an object towards its final shape. Thus, the dentist may be said to be “fashioning” a temporary when he advances its formation relative to a starting shape.

The dentist carefully shapes the temporary, using a variety of trimming and polishing techniques suitable to the material employed. Shaping is critical so as to conform the interior surface of the temporary to the underlying prepared tooth, and so as to conform the exterior surfaces of the temporary to the closure opposite, i.e., to achieve proper occlusal contact with the surface of the opposing tooth. Additionally, margins of the temporary are trimmed to allow proper spacing relative to neighboring dental and maxillofacial surfaces.

It is sometimes the case (such as in situations involving more than few teeth are involved or for aesthetic zone treatment) that a temporary is preliminarily fabricated by a dental lab before the dental appointment where the patient's teeth are trimmed. Typically, on the basis of a preliminary impression, the lab prepares a temporary prosthetic that is like a shell, with the inner part empty and ready to be relined. Lab temporaries may be more finely detailed, stronger, and longer lasting than temporaries fashioned by the dentist in situ, and are typically of higher aesthetic quality. That said, the scope of the present invention encompasses temporaries formed in this manner or any other, and interim prosthetics that are relined in order to provide precisely detailed margin line and surfaces.

Under certain circumstances, an impression may be taken of the patient jaw with the temporary in place on its retaining tooth (or teeth, as in the case of a bridge). This impression serves as a “pickup impression” in that the impression is removed from the patient mouth with the temporary retained in the impression.

In accordance with preferred embodiments of the present invention, instead of taking an impression for use as an intermediary for fine detailed three-dimensional information of the prepared tooth, the temporary itself is optically scanned, at the very location where the dental patient is being treated, in order to derive high-quality three-dimensional digital data from which a definitive prosthesis is fabricated using standard techniques.

Moreover, in accordance with further embodiments of the present invention, the pickup impression itself may also serve as a basis for deriving three-dimensional data by optical scanning at the dentist's office, both with the temporary embedded in the pickup impression, and with the temporary removed, in order to acquire the complementary surface structure with high fidelity and resolution.

Scanning of the temporary may be performed, within the scope of the present invention, using any sort of contact or non-contact surface characterizing equipment. However, it is to be noted that use of a collinear probe, such as a conoscopic probe, is desirable, and, in some cases, essential, because of the sharp angles, vertical surfaces and undercuts and deep cavities inherent in the morphology of crowns, particularly their recessed interior surfaces that envelop prepared underlying teeth. This feature is particularly prominent with respect to front teeth, and requires that the scanning sensor allow for the measurement of deep ‘pits.’

One limitation imposed by existing coordinate measuring machines (CMMs) is due to the fact that even the most versatile optical sensors are unable to digitize on vertical or very steep angles measured with respect to the optical axis (or ‘line of sight’) of the probe. ‘Vertical’, in this case, refers to the surface of the scanned body lying parallel to the optical axis of the probe. An ‘undercut’ refers to a negative angle relative to the line of sight.

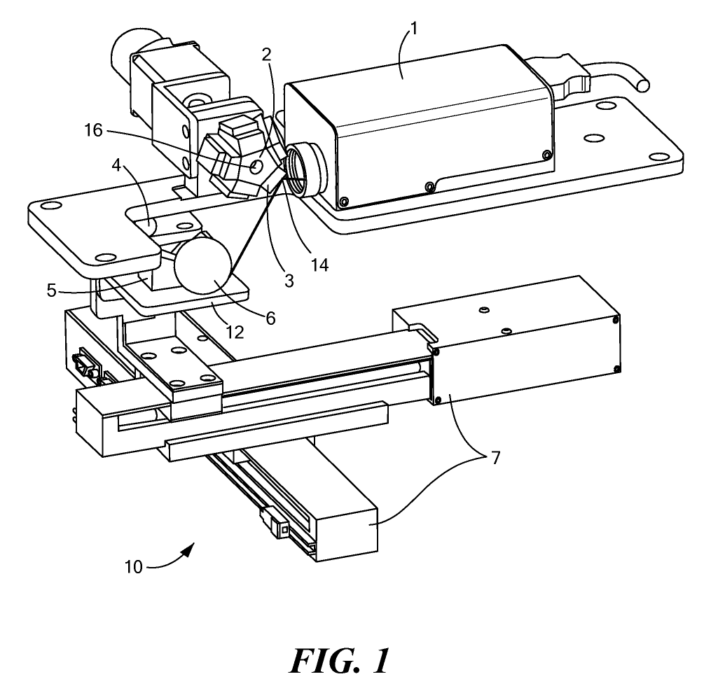

Surfaces characterized by steep angles, such as prevalent in interim prostheses, may be advantageously mapped by means of a conoscopic scanning system of the sort provided by the Optimet Dental Scanner of Optimet (Optical Metrology) Corporation. Such a system is described in detail in U.S. Pat. No. 7,375,827 (Sanilevici, et al.), and one embodiment is now described with reference to FIG. 1.

FIG. 1 shows a perspective view of the salient components of a scanning system. The temporary prosthesis, here represented schematically by a spherical object 6, is disposed on carriage 12 of a CMM, designated generally by numeral 10. The use of any three-dimensional co-ordinate measuring device or equipment is encompassed within the scope of the present invention. Reference bodies may also be disposed on carriage 12 (also referred to as a ‘support’) so as to travel in synchrony with object 6 as it is translated by the carriage. Two reference bodies are shown in FIG. 1: a reference sphere 4 and an angular reference V prism 5. Carriage 12 may be translated, along orthogonal axes, as by means of orthogonal X-Y translation stages 7, however all means of translating object 6 during the course of scanning is within the scope of the present invention. Other means of moving carriage 12 along a known trajectory include motion along a vertical (Z) axis and rotation about one or more specified axes.

A distance probe 1 is typically characterized by an optical axis or line of sight, designated, in FIG. 1, by the line denoted by numeral 14. In preferred embodiments of the invention, a laser beam is emitted collinearly with optical axis 14 of the distance probe. Distance probe 1 is a non-contact sensor such as a conoscopic sensor, or any other distance probe. Distances are measured relative to one or more fiducial positions along the optical axis.

Line of sight 14, and the laser beam coaligned with it, is bent by one or more folding mirrors 3 so that the line of sight impinges upon the surface of scanned body 6. It is to be understood that the optical path shown is described for purposes of convenience and that more complex optical paths, entailing any other optical elements, are within the scope of the present invention and described herein and as claimed in any appended claims.

In accordance with preferred embodiments of the invention, a plurality of folding mirrors 3 are mounted on a multi-position actuator 2 in such a way to allow laser beam bending in different directions. Multi-position actuator 2 may be a carousel supporting multiple mirrors that is rotated about a central axis 16. More particularly, mirrors 3 may be mounted on a polygon, such as the pentagon shown in FIG. 1. Mirrors 3 may be reflecting surfaces fashioned in the carousel in a continuous or discontinuous sequence of normal directions. The mirrors may also be mounted in preset positions, as shown in FIG. 1. The normal directions of successive reflecting surfaces are disposed at varying angles with respect to the plane normal to the axis of rotation of multi-position actuator 2. Such disposition of reflective surfaces on the actuator 2 in FIG. 1 is illustrated by unequal angles A and B between the respective normals to the reflective surfaces of two adjacent mirrors 3 and the central axis 16. Thus, as the actuator is rotated, the line of sight of the distance probe does not sweep out a plane but varies over a range of angles, typically on the order of ±20° with respect to the orthogonal plane.

Measurements of distances to the surface of body 6 along line of sight 14 are collected and processed separately for each of the mirrors 3, thus forming a distinct ‘cloud’ of points attributable to that mirror. Merger (or ‘stitching’) of the respective clouds of points to form a single consistent image is discussed below.

In the case where mirrors 3 are disposed at preset angles, after assembly an accurate measurement of each bending angle is performed for each position of the actuator. The measured angle values are transferred to the software and used for the coordinate transformation from a coordinate system based on motion of the scanning system 7 to an orthogonal coordinate system. Since the line of sight is incident onto the surface of the object at an angle that is specific to each mirror position, a separate coordinate system attaches to each position of the mirror until coordinates are transformed to an orthogonal system.

Desired bending angles may be calculated for a particular application in order to cover the desired undercut angle and leave enough working range. Mirrors 3 may then be set accordingly. High bending angles will reduce the actual working range relative to vertical position and require larger travel for the moving stages.

It is to be noted that the main scanning movement (typically X-Y) may be performed either by the measured object and reference samples fixed on a mounting table or, as a matter of design choice, by the sensor mounted together with the folding mirrors on a common support. Both equivalent motions are within the scope of the present invention.

Data from the measurements described herein are advantageously gathered and processed automatically and without human intervention. In order to increase accuracy of measurement, a fixed reference object (sphere 4, V prism 5) may be scanned before the part is scanned, enabling an accurate calibration of the beam position relative to the X-Y scanning system 7.

All the gathered data for each mirror position is processed first by applying the angular correction for the profiles to orthogonal coordinates and then an origin shift, using the spherical fit to translate the local coordinates to the same origin in a frame of reference fixed with respect to the body. Since the measured object 6 remains fixed (relative to the mounting device, carriage 12) for the entire measurement cycle, the actual X, Y coordinates of each point are the same for all beam positions, thus simple robust mathematical methods are advantageously employed for data processing in a totally automatic cycle.

Using the foregoing, or another, scanning modality, two sides of the temporary are scanned and registered to form a complete set of three-dimensional data from which a definitive prosthesis may be fashioned at a dental laboratory. Registration may be performed using external registration features on a holder which may also be scanned. Two-sided measurement and subsequent registration is described in U.S. patent application Ser. No. 11/829,471, which is incorporated herein by reference.

In accordance with other embodiments of the present invention, characterization of the three-dimensional structure of the temporary may be performed intraorally, such as by means of an intraoral 3-D camera.

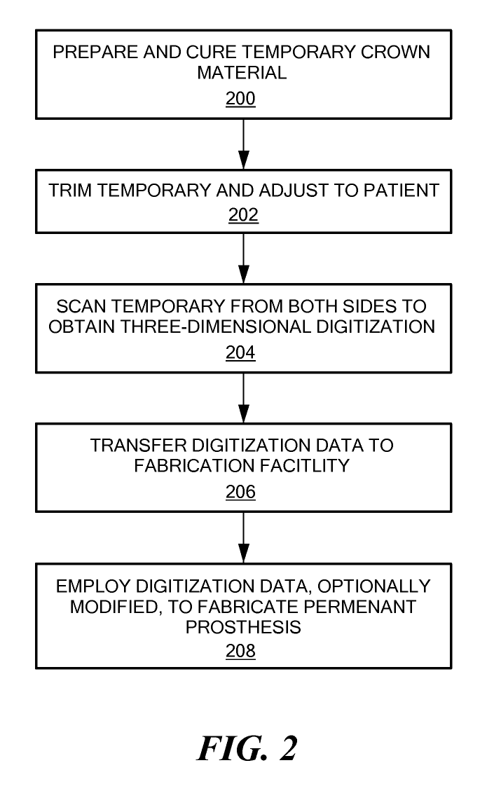

Referring to FIG. 2, typical steps of a method in accordance with the present invention are shown. A temporary is formed by the dentist, and cured as necessary (step 200). The dentist further adjusts the temporary to conform to the mouth of the patient, trimming as appropriate (step 202). The temporary is scanned from both sides (204) to provide three-dimensional digitization which is then transferred to a fabrication facility (206). Additionally, or in the alternative, a pickup impression may be scanned, either with, or without the embedded temporary, or both. The transfer may be by any means of transportation or communication, by wire or wirelessly. The data are then employed in the manual or automated fabrication of a definitive prosthesis (208).

In the manufacture of the definitive prosthesis, data provided by the dentist on the basis of scanning either the temporary or the pickup impression (or both) may be supplemented to include more detailed morphologies, on the basis of data obtained from an analog tooth (on the opposite side of the patient's jaw) or from a library of tooth anatomy. Moreover, account may be taken of a spacing required for interposition of bonding material and for connection to adjacent teeth in the case of bridges, etc. All such modification and enhancement may be performed using CAD-type software.

It is to be understood that, within the scope of the present invention, other information may be obtained in the mouth of the patient and scanned to provide further data for fabrication of a precise prosthetic at a remote site. For example, a mold or cube conforming to the prepared underlying tooth or abutment may be scanned, using technology capable of scanning steep vertical angles, as described above, in order to enable remote fabrication of a prosthesis.

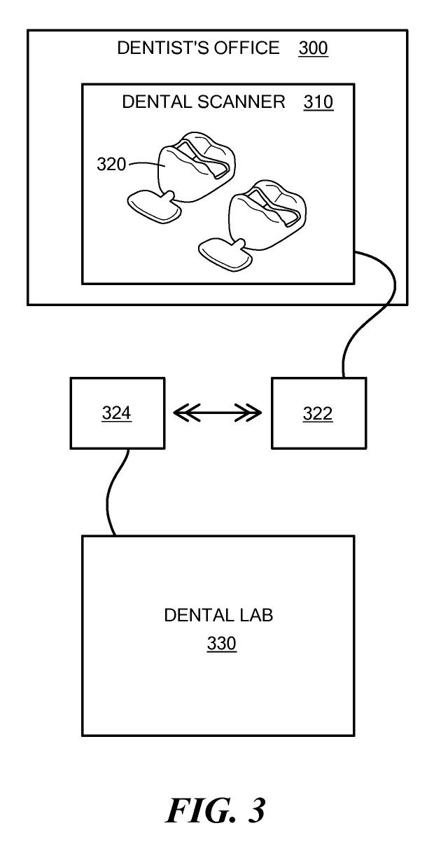

FIG. 3 schematically depicts the constellation of locales in which the methods described in accordance with the present invention may advantageously be practiced. Dental scanner 310 is employed at dentist's office 300 (or local lab, convenient to the patient) in order to scan temporary 320 (and a pickup impression, additionally, or in the alternative). Digitization data from dental scanner 310 is conveyed, via transponder 322 to transponder 324 associated with dental lab 330 (or other fabrication site), which may be a remote site. A definitive prosthesis is prepared at dental lab 330, applying known adjustment for the manufacturing process, to include effects of the porcelain layer, shrinkage, minimal thickness requirements, material strength etc. The definitive prosthesis is then installed in the mouth of the patient.

One or more of the following advantages may be realized due to practice of methods in accordance with the present invention:
1. Immediate three dimensional information may be obtained with respect to both the internal and external occlusion surfaces and margin lines of the requisite prosthesis. Since the dentist defines the margin line (based on the temporary crown) according to the actual situation of the patient, the scan performed at the dentist's office, in accordance with the present invention, retrieves, with high fidelity, the margin line that the dentist has shaped and defined.
2. All the information obtained is based on exact modeling in the patient's mouth.
3. At least in some cases, the need to take any impression at all is obviated.
4. There may be no need to prepare the tooth, especially the gum area, for impression taking. That includes also using a cord or a metal ring or some other method to separate the gum from tooth in the areas under the preparation line.
5. The occlusion impact on the crown bridge is determined, in situ, by the dentist. This impact includes real close of the two jaws at the patient mouth, monitored by the dentist and also includes the occlusive jaw movement
6. The extraction or calculation of the margin line (usually done in a CAD software) from the three dimensional information is advantageously simplified by practicing the present invention.
7. The use of a CAD software for the design is minimized, and in cases where the temporary tooth is well shaped, there is no need for a CAD software to design the tooth. This is due to the fact that the three dimensional information relates already to the entire anatomy of the crown and not the tooth shape.
8. This procedure allow for immediate manufacturing of full anatomy crowns and bridges with minimal design in the CAD.
9. There is no need to take or scan opposite occlusion teeth.
10. Actual occlusion data may be obtained based on operation of the temporary within the mouth of the patient.
11. The scan is done at the dentist office, and, thus, a far shortened treatment cycle is achieved.
12. No change in the clinical procedure is needed, and, additionally, certain steps are obviated, as discussed above.
13. The accuracy of the procedure is increased because of direct extraction of three-dimensional information, and elimination of unnecessary steps. Certain quality control steps may be saved.
14. The crown anatomy accords with the dentist's choice, and, additionally, the patient becomes an active partner in the process and may readily provide input concerning comfort, aesthetics, occlusion, speech and other functions.

In alternative embodiments of the present invention, the disclosed methods for deriving data for the fabrication of a dental prosthesis may be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or analog communications lines) or a medium implemented with wireless techniques (e.g., microwave, infrared or other transmission techniques). The series of computer instructions embodies all or part of the functionality previously described herein with respect to the system. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software (e.g., a computer program product).

The described embodiments of the inventions are intended to be merely exemplary and numerous variations and modifications will be apparent to those skilled in the art. All such variations and modifications are intended to be within the scope of the present invention as defined in the appended claims.

What is claimed is:

1. A method for obtaining data requisite for fabrication of a dental restorative prosthesis, the method comprising:
a. fashioning a temporary at a site of patient treatment, the temporary characterized by an exterior and an interior surface;
b. fitting the temporary within a mouth of a patient;
c. obtaining three-dimensional digital data characterizing the temporary based on the distances measured by means of a three dimensional co-ordinate measuring device; and
d. transmitting the three-dimensional digital data to a fabrication site.

2. A method in accordance with claim 1, further comprising:
fabricating the restorative dental prosthesis on the basis of the three-dimensional digital data.

3. A method in accordance with claim 1, further comprising:
providing information to a dentist at the site of patient treatment, wherein the information is based upon the three-dimensional digital data characterizing the temporary.

4. A method in accordance with claim 3, wherein the information includes at least one of a thickness of the prosthesis at a specified portion of the prosthesis, prosthesis end-line quality, and an insertion axis of the prosthesis.

5. A method in accordance with claim 1, wherein the temporary is an interim prosthesis.

6. A method in accordance with claim 1, wherein the step of obtaining three-dimensional digital data characterizing the temporary further includes measuring distance with respect to at least one fiduciary position.

7. A method in accordance with claim 6, wherein the step of measuring distance includes measuring distances along paths collinear with an optical axis of a distance probe

8. A method in accordance with claim 6, wherein the step of measuring distance includes measuring multiple sides of the temporary and co-registering data obtained on each side.

9. A method in accordance with claim 8, wherein co-registering employs external registration features on a holder.

10. A method in accordance with claim 1, further comprising measuring distances to a pickup impression in which the temporary is embedded.

11. A computer-implemented method for supplying specifications for fabrication of a dental prosthesis, the method comprising:
a. digitizing distances measured with respect to a temporary by means of three-dimensional co-ordinate measuring equipment;
b. converting the distances to three-dimensional data characterizing the temporary;
c. receiving the three-dimensional data at a remote location; and
d. designing a prosthesis on the basis of the received three-dimensional data, thereby creating a prosthesis design.

12. A computer-implemented method in accordance with claim 10, further comprising: fabricating a prosthesis on the basis of the prosthesis design.

13. A computer-implemented method in accordance with claim 11, further comprising: receiving input for editing the prosthesis design.

14. A computer-implemented method in accordance with claim 12, further comprising: editing the prosthesis design on the basis of the input received.

15. A computer program product for use on a computer system for supplying specifications for fabrication of a dental prosthesis, the computer program product having computer readable program code thereon, the computer readable program code including:
a. program code for reading digitized distances measured with respect to a dental temporary by means of three-dimensional co-ordinate measuring equipment;
b. program code for converting the distances to three-dimensional data;
c. program code for designing a prosthesis on the basis of the three-dimensional data, thereby creating a prosthesis design; and
d. program code for editing the prosthesis design prior to transmission of the prosthesis design to a remote location for prosthesis fabrication.
